(19) United States
(12) Patent Application Publication
(10) Pub. No.: US 2023/0334338 A1
(43) Pub. Date: Oct. 19, 2023

(54) PREDICTING A FUTURE BEHAVIOR BY APPLYING A PREDICTIVE MODEL TO EMBEDDINGS REPRESENTING PAST BEHAVIORS AND THE FUTURE BEHAVIOR

(71) Applicant: Meta Platforms, Inc., Menlo Park, CA (US)

(72) Inventors: Seungwhan Moon, Bellevue, WA (US); Xiao Wu, Kirkland, WA (US)

(21) Appl. No.: 16/024,310

(22) Filed: Jun. 29, 2018

(51) Int. Cl. G06N 3/08; G06N 5/02

(52) U.S. Cl. CPC G06N 5/02; G06N 3/08

(57) ABSTRACT

A system for user behavior prediction generates a first series of behavior event elements describing a first set of behaviors of one or more users, upon processing user interactions with an online system. In a first flow, the system generates a first series of time-distributed embeddings of the behavior event elements, and in a second flow parallel with the first flow, the system generates a proposed future embedding of a proposed future behavior of a user at a future time point subsequent to the first set of time points. Using a predictive model (e.g., a recursive neural network), the system transforms components of the first and second flows into an output describing plausibility of occurrence of the proposed future behavior of the user.

### BACKGROUND

This disclosure relates generally to user behavior prediction, and more specifically to generating predictions of future behaviors based on a sequence of past behaviors, using neural networks.

Historical behaviors of users of products or services are often tracked to guide product/service improvement or produce a desired outcome. While analysis of historical behaviors can be used to directly guide design adjustments, the ability to predict future behaviors of users can be extremely valuable in the context of product/service improvement and in other contexts. However, it is extremely challenging to predict behaviors of humans or other subjects based on historical behaviors. As such, there is a need to create a new method and system for behavior encoding, modeling, and predicting. The invention(s) described herein create such a new method and system for behavior encoding, modeling, and predicting.

### SUMMARY

An online system predicts a user’s future behavior(s) based on past behaviors (e.g., actions associated with interactions between users and direct objects within a mobile or web application platform), where a user behavior can be expressed in a data structure as a type of engagement in connection with a topic or direct object (e.g., in a text string) and an associated time stamp. The system trains a predictive model (e.g., a recurrent neural network with one or more long-short term memory blocks) that receives a sequence of past behavior inputs, one or more predicted future behaviors, and outputs a probability of the occurrence(s) of the future behavior(s). Each behavior in the model can additionally or alternatively be expressed in a data structure as a combination of engagement type, topic or direct object, data collection source (e.g., pixel id), behavior type/classification, time stamp, and any other suitable data component. In one variation, an intermediate layer of the trained predictive model can provide embeddings for each behavior data component, which can be within a single latent space and used for comparisons in other contexts and applications.

### BRIEF DESCRIPTION OF THE DRAWINGS

FIG. 1 is an example of an application of embodiments of the method and system for user behavior prediction.

FIGS. 2A and 2B depict variations of system environments associated with an online system implementing embodiments of a method for user behavior prediction.

FIG. 3 is a block diagram of an embodiment of a method for user behavior prediction.

FIG. 4 is an example of an input component for a method for user behavior prediction.

FIG. 5 depicts an embodiment of model architecture implemented in a method and system for user behavior prediction.

FIG. 6 depicts a variation of model architecture implemented in a method and system for user behavior prediction.

FIG. 7 depicts an additional application associated with a variation of a block of a method for user behavior prediction.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### 1. An Example of Behavior Prediction Associated With User Interactions Within an Online System

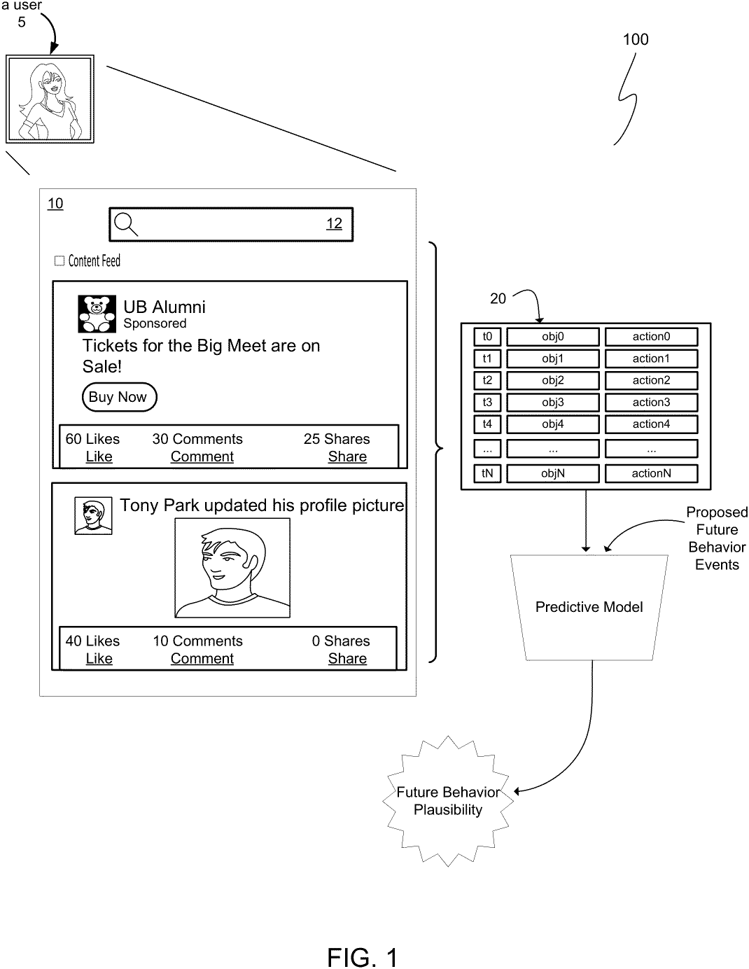

As shown in FIG. 1, an example of a method 100 associated with a system 200 for behavior prediction captures and transforms user interactions within an online system into an output that can be used to improve function of the online system and/or other aspects of user life. In the example, content 10 is presented to a user 105, in accordance with an embodiment. In the example of FIG. 1, the user 105 is a consumer and/or generator of content of an online system. Content 10 is provided to the user 5 with interaction features (e.g., a search bar 12, hyperlinked elements, online elements editable by one or more users in association with user accounts, elements with tracking functionality, etc.), whereby interaction with the interaction features by one or more users is captured to log and generate behavior event elements 20 for the user(s). Such behavior event elements are processed with a predictive model, in combination with a proposed future behavior, to generate a prediction of future behavior plausibility, wherein embodiments, variations, and examples of the prediction model are described in more detail below. Outputs of the method 100 and system can be used to improve function of the online system and/or other aspects of user life (e.g., by providing improved electronic content, by providing tailored guidance to the user in relation to predicted future behaviors, by manipulating operational states of devices within environment(s) of the user(s), etc.), as described below.

### 2. Overview of System Environment

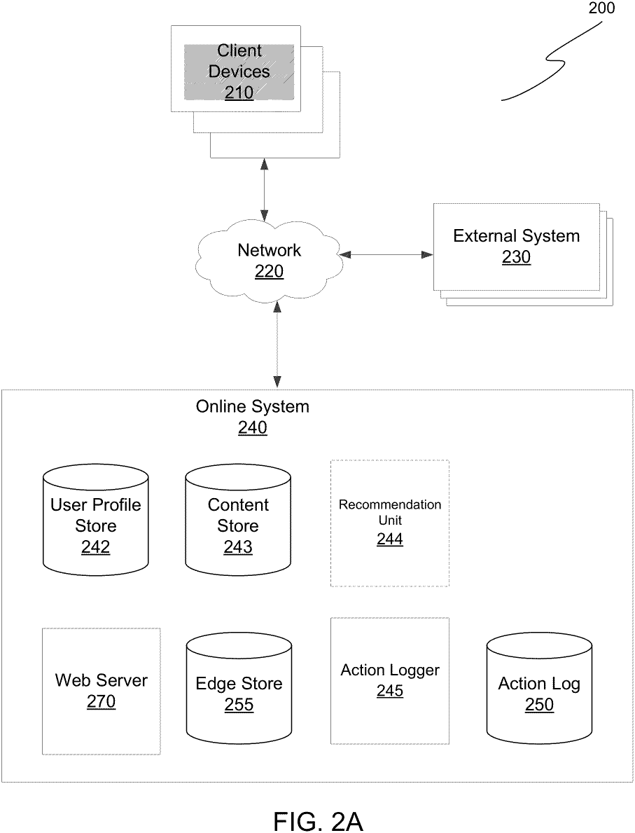

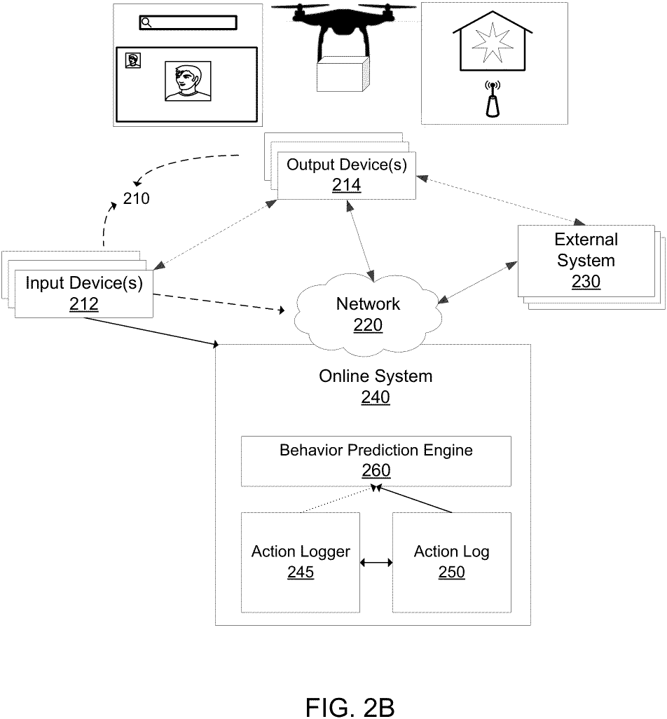

FIG. 2A is a system environment 200 of an online system 240. The system environment 200 shown by FIG. 2A comprises one or more client devices 210, a network 220, one or more external systems 230, and the online system 240. In alternative configurations, one of which is shown in FIG. 2B, different and/or additional components may be included in the system environment 200. The embodiments described herein can be adapted to online systems that are not social networking systems.

The client devices 210 can include one or more computing devices capable of receiving user input as well as transmitting and/or receiving data via the network 220. In one embodiment, a client device 210 is a conventional computer system, such as a desktop or laptop computer. Alternatively, a client device 210 can be a device having computer functionality, such as a personal digital assistant (PDA), a mobile telephone, a smartphone, a wearable computing device (e.g., a wrist-borne wearable computing device, a head-mounted wearable computing device, etc.), or another suitable device. A client device 210 is configured to communicate via the network 220. In one embodiment, a client device 210 executes an application allowing a user of the client device 210 to interact with the online system 240. For example, a client device 110 executes a browser application to enable interaction between the client device 210 and the online system 240 via the network 220. In another embodiment, a client device 210 interacts with the online system 240 through an application programming interface (API) running on a native operating system of the client device 210, such as IOS® or ANDROID™.

The client devices 210 are configured to communicate via the network 220, which may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more external systems 230 (e.g., third party systems) can be coupled to the network 220 for communicating with the online system 240. In one embodiment, an external system 230 is an application provider communicating information describing applications for execution by a client device 210 or communicating data to client devices 210 for use by an application executing on the client device. In other embodiments, an external system 230 provides content or other information for presentation via a client device 210. An external system 230 may also communicate information to the online system 240, such as advertisements, content, or information about an application provided by the external system 230.

The online system 240 allows its users to post content to the online system 240 for presentation to other users of the online system 240, allowing the users interact with each other. Examples of content include stories, photos, videos, and invitations. Additionally, the online system 240 typically generates content items describing actions performed by users and identified by the online system 240. For example, a content item is generated when a user of an online system 240 checks into a location, shares content posted by another user, or performs any other suitable interaction. The online system 240 presents content items describing an action performed by a user to an additional user (e.g., the viewing user 105) connected to the user via a multi-task neural network model that predicts how likely the additional user will interact with the presented content items.

The online system 240 shown in FIG. 2A includes a user profile store 242, a content store 243, an action logger 245, an action log 250, an edge store 255, and a web server 270. In other embodiments, the online system 240 may include additional, fewer, or different components for various applications. Conventional components such as network interfaces, security functions, load balancers, failover servers, management and network operations consoles, and the like are not shown so as to not obscure the details of the system architecture.

Each user of the online system 240 is associated with a user profile, which is stored in the user profile store 242. A user profile includes declarative information about the user that was explicitly shared by the user and may also include profile information inferred by the online system 240. In one embodiment, a user profile includes multiple data fields, each describing one or more attributes of the corresponding user of the online system 240. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 240 displayed in an image. A user profile in the user profile store 242 may also maintain references to actions by the corresponding user performed on content items in the content store 243 and stored in the action log 250.

While user profiles in the user profile store 242 are frequently associated with individuals, allowing individuals to interact with each other via the online system 240, user profiles may also be stored for entities such as businesses or organizations. This allows an entity to establish a presence on the online system 240 for connecting and exchanging content with other online system users. The entity may post information about itself, about its products or provide other information to users of the online system 240 using a brand page associated with the entity’s user profile. Other users of the online system 240 may connect to the brand page to receive information posted to the brand page or to receive information from the brand page. A user profile associated with the brand page may include information about the entity itself, providing users with background or informational data about the entity.

The content store 243 stores objects that each represent various types of content. Examples of content represented by an object include a page post, a status update, a photograph, a video, a link, a shared content item, a gaming application achievement, a check-in event at a local business, a brand page, or any other type of content. Online system users can create objects stored by the content store 243, such as status updates, photos tagged by users to be associated with other objects in the online system 240, events, groups, links to online content, or applications. In some embodiments, objects are received from third-party applications or third-party applications separate from the online system 240. In one embodiment, objects in the content store 243 represent single pieces of content, or content “items.” Hence, users of the online system 240 are encouraged to communicate with each other by posting text and content items of various types of media through various communication channels. This increases the amount of interaction of users with each other and increases the frequency with which users interact within the online system 240.

In various embodiments, a content item includes various components capable of being identified and retrieved by the online system 240. Example components of a content item include: a title, text data, image data, audio data, video data, a landing page, a user associated with the content item, or any other suitable information. The online system 240 an retrieve one or more specific components of a content item for presentation in some embodiments. For example, the online system 240 can identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, searching for a content item, viewing a content item, purchasing a product or service associated with a content item, or performing any other suitable interaction. As content from a content item is presented to online system users, the online system 240 logs interactions between users presented with the content item or with objects associated with the content item. Additionally or alternatively, the online system 240 receives compensation from a user associated with content item as online system users perform interactions with a content item that satisfy the objective included in the content item.

Additionally, a content item may include one or more targeting criteria specified by the user who provided the content item to the online system 240. Targeting criteria included in a content item request specify one or more characteristics of users eligible to be presented with the content item. For example, targeting criteria can be used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria can specify actions or types of connections between a user and another user or object of the online system 240. Targeting criteria can also specify interactions between a user and objects performed external to the online system 240, such as on an external (e.g., third party) system 230. For example, targeting criteria identifies users that have taken a particular action, such as viewed content from a vendor, searched for content from a vendor, purchased a product or service (e.g., using an online marketplace), sent a message to another user, used an application, joined a group, left a group, joined an event, generated an event description reviewed a product or service using an online marketplace, requested information from an external (e.g., third party) system 230, installed an application, or performed any other suitable action. Outputs of the method 100 described below, in relation to future behavior prediction from one or more users, can further be used as factors in developing targeting criteria. Including actions in targeting criteria allows users to further refine users eligible to be presented with content items. As another example, targeting criteria identifies users having a connection to another user or object or having a particular type of connection to another user or object.

The action logger 245 receives communications about user actions internal to and/or external to the online system 240, populating the action log 250 with information about user actions. Examples of actions include adding a connection to another user, sending a message to another user, uploading an image (or other content), reading a message from another user, viewing content associated with another user, attending an event posted by another user, among others. In addition, a number of actions may involve an object and one or more particular users, so these actions are associated with those users as well and stored in the action log 250.

The action log 250 can be used by the online system 240 to track user actions on the online system 240, as well as actions on external systems 230 that communicate information to the online system 240. Users can interact with various objects on the online system 240, and information describing these interactions are stored in the action log 250. Examples of interactions with objects include: viewing objects, purchasing objects, performing a search related to objects, commenting on posts, sharing links, and checking-in to physical locations via a mobile device, accessing content items, and any other interactions. Additional examples of interactions with objects on the online system 240 that are included in the action log 250 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 250 may record a user’s interactions with advertisements on the online system 240 as well as with other applications operating on the online system 240. In some embodiments, data from the action log 250 is used to infer interests or preferences of a user, augmenting the interests included in the user’s user profile and allowing a more complete understanding of user preferences.

The action log 250 can also store user actions taken on an external system 230, such as an external website, and communicated to the online system 240. For example, an e-commerce website that primarily sells sporting equipment at bargain prices may recognize a user of the online system 240 through a social plug-in (e.g., that uses a tracking pixel) enabling the e-commerce website to identify the user of the online system 240. Because users of the online system 240 are uniquely identifiable, e-commerce websites, such as this sporting equipment retailer, may communicate information about a user’s actions outside of the online system 240 to the online system 240 for association with the user. Hence, the action log 250 may record information about actions users perform on the external system 230, including webpage viewing histories, advertisements that were engaged, purchases made, and other patterns from shopping and buying.

The edge store 255 can store information describing connections between users and other objects on the online system 240 as edges. Some edges can be defined by users, allowing users to specify their relationships with other users. For example, users may generate edges with other users that parallel the users’ real-life relationships, such as friends, co-workers, partners, and so forth. Other edges can be generated when users interact with objects in the online system 240, such as expressing interest in a page on the online system 240, sharing a link with other users of the online system 240, and commenting on posts made by other users of the online system 240. Users and objects within the online system 240 can represented as nodes in a social graph that are connected by edges stored in the edge store 255.

An edge can include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 240, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 255 also stores information about edges, such as affinity scores for objects, interests, and other users. Affinity scores, or “affinities,” can be computed by the online system 240 over time to approximate a user’s interest in an object or in another user in the online system 240 based on the actions performed by the user. A user’s affinity can be computed by the online system 240 over time to approximate the user’s interest in an object, in a topic, or in another user in the online system 240 based on actions performed by the user. Computation of affinity is further described in U.S. Pat. Application No. 12/978,265, filed on Dec. 23, 2010, U.S. Pat. Application No. 13/690,254, filed on Nov. 30, 2012, U.S. Pat. Application No. 13/689,969, filed on Nov. 30, 2012, and U.S. Pat. Application No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 242, or the user profile store 242 may access the edge store 255 to determine connections between users.

The web server 270 links the online system 240 via the network 220 to the one or more client devices 210, as well as to the one or more external systems 230. The web server 270 serves web pages, as well as other web-related content, such as JAVA®, FLASH®, XML and so forth. The web server 270 may receive and route messages between the online system 240 and the client device 210, for example, instant messages, queued messages (e.g., email), text messages, short message service (SMS) messages, or messages sent using any other suitable messaging technique. A user may send a request to the web server 270 to upload information (e.g., images or videos) that are stored in the content store 243. Additionally, the web server 270 may provide application programming interface (API) functionality to send data directly to native client device operating systems, such as IOS®, ANDROID™, WEBOS® or RIM®.

In a variation of the system environment 200 described above, the online system 240, as shown in FIG. 2B, can include a behavior prediction engine 260, which includes blocks implemented in software and hardware in an integrated system. The behavior prediction engine 260 preferably implements one or more blocks of the method 100 described below, in relation to processing behaviors captured in the action logger 245 and/or action log 250 with a predictive model, and generating outputs that can be used to improve function of the online system 240 and/or other aspects of user life through user interactions with input devices 212 and/or output devices 214.

Input devices 212 can include one or more of: touch control input devices, audio input devices, optical system input devices, biometric signal input devices, and/or any other suitable input devices. Output devices 214 can include one or more of: displays, light emitting elements, audio output devices, haptic output devices, temperature modulating devices, olfactory stimulation devices, virtual reality devices, augmented reality devices, other stimulation devices, delivery vehicles (e.g., aerial delivery vehicles, terrestrial delivery vehicles, nautical delivery vehicles, etc.), printing devices, and/or any other suitable output devices. In some variations, such output devices 214 can be wirelessly coupled or otherwise coupled to the network 220, external system(s) 230, and/or input device 212, in order to receive control instructions for entering or transitioning between operation states. As described in further detail below, such operation states can be associated with device activation, device inactivation, device idling, stimulation output states (e.g., light output states, audio output states, temperature adjustment states, olfactory output states, etc.), delivery operation states of aerial or other delivery vehicles, printing states, states associated with electronic content provision to the user(s), and/or any other suitable output device states. Furthermore, client devices 210 described above can include or otherwise be associated with the input devices 212 and/or output devices 214.

While the system(s) described above preferably implement embodiments, variations, and/or examples of the method(s) 100 described below, the system(s) can additionally or alternatively implement any other suitable method(s).

### 3. Method for Behavior Prediction With Distributed Encoding Based on User Event Sequence(s)

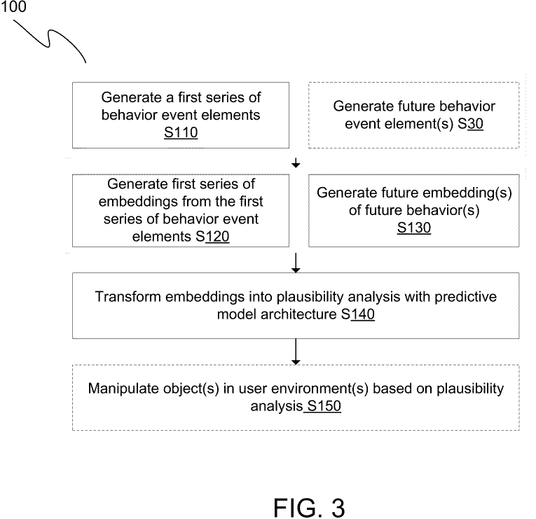

As shown in FIG. 3, a method 100 for behavior prediction includes: generating a first series of behavior event elements describing a first set of behavior events across a first set of time points S110; generating a first series of time-distributed embeddings of the behavior event elements S120; generating at least one proposed future embedding of a proposed future behavior event associated with one or more users at a future time point S130; and transforming embeddings into an output comprising a plausibility metric describing plausibility of occurrence of the proposed future behavior event(s) of the user(s) S140. Variations of the method 100 can additionally or alternatively include Block S150, which includes functionality for, at an output device, manipulating an object in an environment of the user, based upon a set of instructions derived from the output and provided to the output device. The method 100 can function to predict sequences of future behaviors of users of an online system based upon other sequences of behaviors (e.g., historical behaviors, non-historical behaviors). The predicted future behavior(s) can then be used to manipulate operational states of devices and/or other objects in the environment(s) of the associated user(s), to provide improved products, services, and/or other aspects of user life.

### 3.1 Method - Extracting and Generating Behavior Event Elements

Block S110 includes functionality for generating a first series of behavior event elements describing a first set of behavior events across a first set of time points, which functions to transform acquired behavior data into a form processable by the predictive model in Blocks S120, S130, and S140 (e.g., as an input layer). The first set of behavior events can be captured and generated by an embodiment, variation, or example of the online system above (e.g., by way of an action logger 245 in coordination with an action log 250) based on processing user interactions with content provided in association with the online system. One or more behavior events can additionally or alternatively be captured by user interactions with behavior tracking sensors of devices (e.g., input devices, wearable computing devices, activity monitoring devices, etc.), interactions between users and other online systems, interactions between users and other external systems, and/or any other suitable interactions between users and other objects that can be captured (e.g., captured electronically) and used to create behavior event elements.

A behavior event element generated in Block S110 can have a composite data structure (e.g., array, vector, etc.) with associated subcomponents capturing aspects of a behavior event using data types appropriate for each subcomponent, wherein data types do not have to be identical across different subcomponents. A behavior event element can additionally or alternatively have any other suitable structure with any other suitable data type(s) (e.g., based upon complexity of behavior events). The behavior event elements can be captured and generated in near-real time as behavior events occur, or can be extracted from historical data non-contemporaneously with occurrence of the behavior events and generated at a later time (e.g., immediately prior to processing with the predictive model).

A behavior event element generated in Block S110 can have one or more of: a time component, an object component, an object type component, an action component, a pixel identifier component, and any other suitable component that can be used to characterize some aspect of the behavior event, to increase predictive ability of the predictive model of Block S140 in generating plausibility analyses associated with future behavior events.

The time component can function to identify occurrence of the behavior event within a sequence of behavior events, and can be represented with a time data type (e.g., string literal format, other format, other custom format) that describes one or more time stamps associated with the behavior event. The time component can describe one or more of: an initiation time of the behavior event, a termination time of the behavior event, a time intermediate initiation and termination of the behavior event, and/or any other suitable time aspect. In association with the time component, the behavior event element can include a subcomponent that indicates number of times the behavior event (or a similar behavior event or a behavior event category) was repeated.

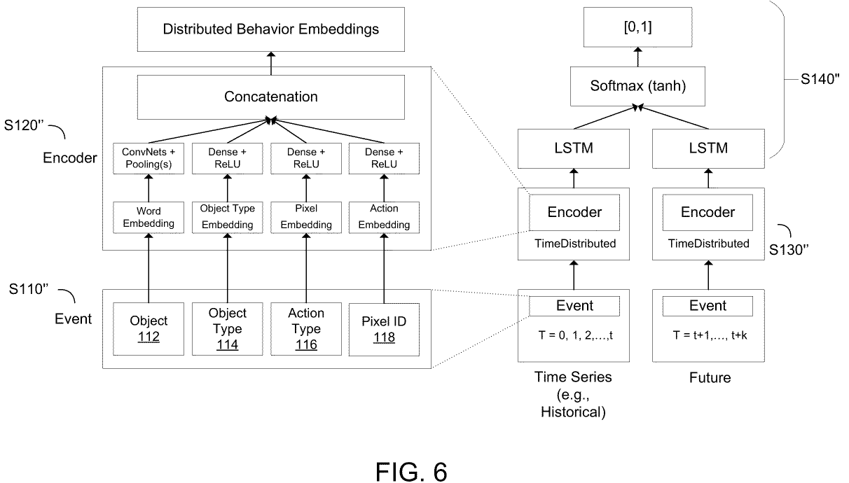

The object component 112, shown in FIG. 6, can function to describe a direct object of an interaction associated with an action component described in more detail below, and can characterize an intended object that the user desires or desires to interact with. The object component can be represented with a character data format (e.g., character string, other format, other custom format) that describes the object of the object component. In variations, the object component can describe direct objects associated with available electronic content provided by way of the online system or associated system components described above, wherein the content can represent one or more of: a product (e.g., provided by an integrated marketplace, provided by an external vendor, etc.), a service (e.g., provided by an integrated marketplace, provided by an external vendor, etc.), another user, another group of users, another entity, an event, a company, or any other suitable object.

The object type component 114, shown in FIG. 6, can function to further categorize the object component (e.g., based one or more classification algorithms), and can be represented with a character data format or any other suitable format/custom format. In examples, object type can be associated with categories for one or more of: an extracurricular activity type associated with the object (e.g., camping, sport, cooking, hobby, etc.), product type (e.g., appliance, edible consumable, drinkable consumable, vehicle, etc.), service type (e.g., legal service, health-related service, financial-related service, lifestyle-related service, etc.), content type (e.g., image content, video content, text content, audio content, etc.), and any other suitable category. Furthermore, a behavior event can have one or more object type components.

The action type component 116, shown in FIG. 6, can function to describe an action or engagement associated with an interaction with the object component. The action component can be represented with a character data format (e.g., converted to a text string) or any other suitable format/custom format. In variations, the action component can be selected from one of a set of populated action types based on a library or space of possible actions that a user can take when interacting with input features of user interfaces created in source code of the user interface and provided by the online system. In examples of such variations, the action component can be selected from one or more of: a searching action, an action associated with consuming content (e.g., viewing content, listening to content, interacting with a link, etc.), an action associated with purchasing a product or service, an action associated with generating or posting content, an action associated with an event status (e.g., accepting an event invitation, declining an event invitation, showing interest in an upcoming event, attending an event, etc.), an action associated with reviewing an object (e.g., product, service, content, entity), an action associated with commenting on content within a text field, an action associated with sharing content, an action associated with an emotional response to content, an action associated with receiving notifications, an action associated with edges of an edge store (e.g., forming an edge, removing an edge), or any other suitable action.

The pixel identifier component 118, shown in FIG. 6, functions to enable identification of a source or node associated with user activity within digital space and/or in association with digital content available to the user (e.g., associated with objects and/or actions). The pixel identifier component can characterize a location of a pixel (or other digital object) in digital space, along with features of the pixel (or other digital object) associated with one or more of entity features (e.g., third party characteristics), features of web/mobile pages surrounding the pixel (or other digital object), and/or any other suitable features.

In relation to tracking pixels, a third party platform associated with the online system through a network can use a tracking pixel (or other digital object defined in code) placed by the third party platform on third-party websites to monitor users, user devices, and/or other features of users visiting the websites that have not opted out of tracking. A tracking pixel can thus be included on various pages, including, for example, a product page describing a product, a shopping cart page that the user visits upon putting something into a shopping cart, a checkout page that the user visits to checkout and purchase a product, a page associated with reviewing a product or service, and/or any other suitable region of the third party platform domain.

In examples, a tracking pixel can be characterized as a transparent 1x1 image, an iframe, or other suitable object being created for third party pages. When a user’s browser loads a page having the tracking pixel, the tracking pixel results in the user’s browser attempting to retrieve the content for that pixel, and the browser contacts the online system to retrieve the content. The request sent to the online system, however, actually includes various data about the user’s actions taken on the third party website. The third party website can control what data is sent to the online system. As such, the tracking pixel can operate as a conversion tracking pixel that performs an action (e.g., communication of desired data components associated with user activity to the online system and/or from the online system to the third party) in response to user behavior within the third party platform.

In more detail, the third party platform can include information about the page the user is loading (e.g., is it a product page, a shopping cart page, a checkout page, etc.), about information on the page or about a product on the page of interest to the user (e.g., the SKU number of the product, the color, the size, the style, the current price, any discounts offered, the number of products requested, etc.), about the user (e.g., the third party’s user identifier (UID) for the user, contact information for the user, etc.), and other data. In some embodiments, a cookie set by the online system can also be retrieved by the online system, which can include various data about the user, such as the online systems’ UID for the user, information about the client device and the browser, such as the Internet Protocol (IP) address of the client device, among other data. Tracking can also be performed on mobile applications of content providers by using a software development kit (SDK) of the online system or via an application programming interface (API) of the online system to track events (e.g., purchases) that occur by users on the content provider’s application that are reported to the online system.

The pixel identifier component can, however, be substituted or supplemented with another activity tracking component associated with online user activity.

As described above, a behavior event element can have any other suitable subcomponent. For instance, a behavior event element can have a subcomponent describing relationships between the behavior event element and another behavior element, or the subcomponent(s) of the behavior element and the subcomponent(s) of another behavior element (or group of behavior elements). In examples, a behavior event element can include a subcomponent associated with similarity with another behavior event element, correlated behavior event elements, and/or any other suitable relationships. In another example, a behavior event element can have a subcomponent associated with interaction intensity. For instance, a subcomponent can determine intensity of an interaction (e.g., based upon a duration of interaction between the user and content from time components, based upon number of entry nodes defined in digital space for accessing content, etc.). A behavior event element can, however, have any other suitable subcomponent.

In Block S110, the behavior event elements used for subsequent processing steps of the method 100 can be derived from a single user or multiple users (e.g., users sharing demographic or other traits). As such, the predictive model can be user independent or user specific. Furthermore, in relation to subsequent processing steps of the method 100, the behavior event elements can be used as training data for predictive model refinement or test data for predictive model use.

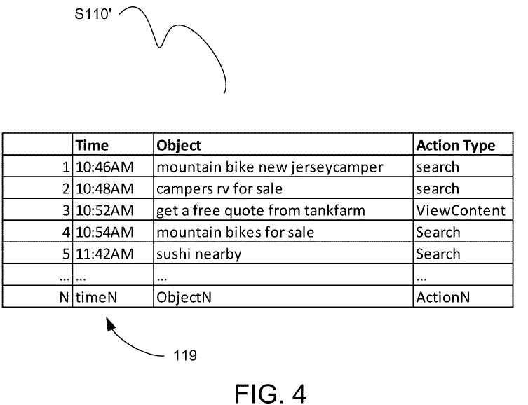

In an example shown in FIG. 4, a stream of behavior event elements generated S110′ can include time stamp components 119 associated with action components corresponding to different object components (e.g., performing a search for “mountain bike new jerseycamper” within a search field, performing a search for “campers rv for sale” within a search field, viewing content associated with “getting a free quote from a provider”, searching for “mountain bikes for sale”, searching for “sushi nearby”, etc.). In the example, and in association with subsequent method blocks, the behavior event elements can be processed to determine plausibility of occurrence of one or more future behavior events (e.g., viewing content associated with “4 reasons why a car rental is better for a family road trip”, performing a search for “portable folding hammock”, viewing content associated with “donald trump teases reporters I have decided on iran nuclear deal”, etc.). Variations of the example shown in FIG. 4 can, however, capture other behavior events for analysis of other future proposed behavior events.

### 3.2 Method - Generating Embeddings

Block S120 includes functionality for generating a first series of time-distributed embeddings of the behavior event elements, which functions to increase efficiency of processing of large inputs to the predictive model by translating the behavior event elements from a high dimensional space to a lower dimensional space. As such, Block S120 can facilitate improvements in relation to functioning of the computing system(s) used to process the behavior event elements associated with an extremely large number of behavior events from an extremely large number of users (e.g., thousands of users, millions of users, billions of users) over long durations of time, to produce outputs that can be used to improve content, products, services, and/or other aspects of user life associated with the user(s) in the method 100. Block S120 can be implemented by processing components of or otherwise associated with the online system or network described above; however, Block S120 can additionally or alternatively be implemented across a network of systems for processing large amounts of data.

Block S120 can include generating the first series of time-distributed embeddings upon encoding the first series of behavior event elements of Block S110 with a set of operations (e.g., in one or more layers of predictive model architecture) applied to the set of components of the behavior event elements. As such, the embeddings preferably retain the time-distributed aspects of sequences of behavior events, with the assumption that each behavior event is defined by its surrounding behavior events; however, in alternative variations of Block S120, the embeddings can be processed in any other suitable manner to have any other suitable distribution.

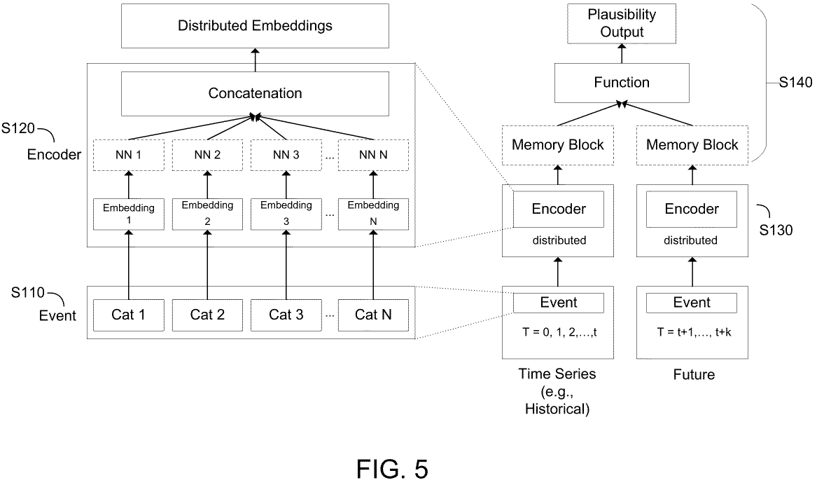

As shown in FIG. 5, the set of operations can include embedding operations corresponding to and appropriate for categories of subcomponents of behavior event elements. Such embedding operations can include one or more of: a word embedding operation (e.g., word2vec, FastText, GloVe, lda2vec etc.), a pixel embedding operation (e.g., a translation from one MxN pixel space to another OxP pixel space, an associative embedding operation, etc.), a family embedding operation, another input data type-to-vector embedding operation, and any other suitable embedding operation. Additionally or alternatively, Block S120 can implement a structured embedding operation for grouped data, in relation to embedding multiple subcomponent types or categories of subcomponents of behavior event elements. In the example shown in FIG. 6, the set of embedding operations of Block S120″ includes a word embedding operation for the object component of a behavior event element, an object type embedding operation for the object type component of a behavior event element, a pixel embedding operation for the pixel identifier component of a behavior event element, and an action embedding operation for the action component of a behavior event element.

As shown in FIG. 5, the set of operations can additionally or alternatively include a set of neural network operations (each with one or more layers) applied to each subcomponent of the behavior event elements. The set of neural network operations can be trained to increase performance (e.g., optimize accuracy) of the predictive model in predicting plausibility of occurrence of the future proposed behavior event(s) of the user(s). However, the set of neural network operations can be trained to increase any other suitable aspect of performance of the predictive model of Block S140. In variations, the set of operations can include one or more of: a a convolutional layer, with a pooling layer, with a normalization layer, a fully-connected layer, a dense layer (e.g., a dense feedforward layer), a rectifier layer (e.g., with a noisy rectifier unit, with a leaky rectifier unit, with an exponential unit, etc.), a dropout layer, and any other suitable layer. In the example shown in FIG. 6, the set of neural network operations of Block S120″ can include a convolutional layer with a pooling layer for word embeddings, and a dense feed forward layer with a rectifier layer (e.g., rectifier layer with a linear unit) for object type embeddings, pixel embeddings, and action embeddings. However, variations of the example can additionally or alternatively include any other suitable layers or combinations of layers for associated embeddings.

The set of operations of Block S120 can additionally or alternatively include a concatenation operation that concatenates outputs of layers of the encoder operation(s) of Block S120 for use in downstream blocks of the method 100. The set of operations of Block S120 can, however, include any other suitable operation(s).

Block S120 can be implemented in a first flow for processing the first series of events with the predictive model of Block S140, in relation to encoding behavior event elements. Wherein the first flow is parallel with a second flow associated with behavior event elements for proposed future behaviors, as described in more detail in relation to Block S130 below.

Block S130 includes functionality for generating at least one proposed future embedding of a proposed future behavior of one or more users at a future time point. Block S130 functions to increase efficiency of processing of large inputs to the predictive model by translating behavior event elements associated with proposed future behavior events from a high dimensional space to a lower dimensional space. As such, Block S130 can facilitate improvements in relation to functioning of the computing system(s) used to process proposed behavior event elements associated with an extremely large number of potential future behavior events from an extremely large number of users (e.g., thousands of users, millions of users, billions of users), to produce outputs that can be used to improve content, products, services, and/or other aspects of user life associated with the user(s) in the method 100. Block S130 can be implemented by processing components of or otherwise associated with the online system or network described above (e.g., as in Block S120).

As shown in FIG. 3, Block S130 can be associated with Block S30, which includes functionality for generating future behavior event elements, which can be implemented in a manner similar to implementation of Block S110, as applied to proposed future behavior events. The proposed future behavior event element subcomponents can be selected from a narrowed or refined subset of potential future event elements, based upon the series of behavior event elements of Block S110. Alternatively, the proposed future behavior event element subcomponents can be selected from a space or library of possible behavior events of a user, in relation to potential interactions with input features of user interfaces created in source code of a user interface provided by the online system described above. The proposed future behavior events can be generated based upon similarity analysis (e.g., to one or more behavior events of Block S110), correlation processing (e.g., to one or more associated or non-associated behavior events of Block S110), or through another analysis. As such, the proposed future behavior event elements can have subcomponents corresponding to subcomponents of the series of behavior event elements of Block S110 and live in the same latent space as the behavior event elements of Block S110. However, the proposed future behavior element(s) can alternatively live in another latent space.

Block S130 can implement operation processes (e.g., embedding processes, encoding processes, neural network operations, etc.) identical to or similar to operation processes implemented in Block S120, in a second flow parallel with the flow of Block S120. Block S130 can be performed contemporaneously with Block S120, or can be performed non-contemporaneously with Block S120. However, Block S130 can additionally or alternatively include other operation processes in flows not associated with Block S120.

As shown in FIGS. 5 and 6, Block S130 and Block S130″ can include generating a set of proposed future embeddings for processing with the predictive model. The proposed future embedding can have corresponding future time points, such that the method 100 can predict plausibility of occurrence of the future behavior event(s) with associated temporal aspects. The time points can indicate times (e.g., absolute times), position within a sequence of proposed future behaviors, repetition of a future behavior event, and/or any other suitable temporal indicator. As such, the proposed future embeddings can also be time-distributed (e.g., with the assumption that future behavior events are defined by surrounding behavior events). However, the proposed future embeddings can alternatively be processed to have any other suitable distribution (e.g., in relation to location of the user when performing actions or other feature of user behavior).

### 3.3 Method - Predictive Model Architecture

Block S140 includes functionality for transforming embeddings into an output comprising a plausibility metric describing plausibility of occurrence of the proposed future behavior(s) of the user(s). In association with Blocks S120 and S130, Block S140 can implement additional layers of predictive model architecture to perform a set of computer-implemented rules that output values of plausibility metrics indicative of probability of occurrence of the proposed future behavior(s).

In combination with layers associated with other blocks of the method 100, and as shown in FIGS. 5 and 6, Block S140 and Block S140″ can form a predictive model having an architecture adapted for prediction of one or more future behavior event occurrences (e.g., a sequence of future behaviors) based upon sequences of historical or other behaviors. The predictive model can have a deep learning architecture, wherein learning can be supervised, semi-supervised, or unsupervised. As such, in light of Blocks S110-S140, the predictive model implemented to generate the output of Block S140 can have a recursive neural network (RNN) architecture (as depicted in FIGS. 5 and 6) with an input layer for the first series of behavior event elements and the proposed future behavior element(s); an encoder layer receiving outputs of the input level and implementing the set of embedding operations, a set of operations mapped to embedding types of the first series of time-distributed embeddings and the proposed future embedding, and a concatenation operation; a memory layer (e.g., a long short-term memory (LSTM) layer) that processes outputs of the encoder layer; and an output layer that generates the output.

The RNN architecture implemented can have a finite impulse structure or an infinite impulse structure. Additionally or alternatively, the RNN architecture can be fully recurrent, recursive, Hopfield-derived, Bidirectional Associative, Elman-derived, Jordan-derived, Echo, stacked, or of any other suitable structure. In relation to the memory layer, the RNN architecture can have a stored states (e.g., gated states, gated memory). The stored states can be part of Long short-term memory block with one or more of a cell, input gate, output gate, and forget gate that collectively function to prevent backpropagated errors from vanishing or exploding. The stored state can, however, be associated with any other suitable memory block architecture.

As shown in FIG. 5, outputs of the memory layer can be fed into a normalization function. The normalization function can be a Softmax function or other normalized exponential function that transforms a vector into a vector of real values in the range (0,1) that add to 1. As such, in the context of plausibility metric values for a set of proposed future behavior events, outputs of the normalization function can produce a vector of real values in the range (0,1), wherein each component of the vector describes plausibility of occurrence of a corresponding future behavior event in the range (0,1), where 1 can represent ground-truth occurrence of a future behavior and 0 can represent randomly sampled negative behavior events. The plausibility metric(s) can additionally or alternatively be used to generate a plausibility analysis associated with probability of occurrence of the proposed future behavior(s) in relation to one or more of: position of a proposed future behavior within a sequence of proposed future behaviors, occurrence of a proposed future behavior in association with one or more specific users, similarity to other proposed behavior events, correlation with other proposed behavior events, and any other suitable output component.

The normalization function can alternatively be another logistic function, and/or the output can be constructed in any other suitable manner to represent plausibility of proposed future behavior events.

As described above, the RNN can be trained using sequences of historical or other behavior events with the online system 240 described above. The behavior prediction engine 260 can, along with the action logger 245 and/or the action log 250 can form a training data set that can be stored. The training data sets include a plurality of inputs, which can have different associated weights. In some variations, the behavior prediction engine 260 can use supervised machine learning to train the prediction model 370. Different machine learning techniques-such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps-may be used in alternative variations. Furthermore, the behavior prediction engine 260 can periodically re-train the predictive model of Blocks S110-S140 using features based on updated training data.

### 3.4 Method - Additional Blocks and Applications

As shown in FIG. 3, the method 100 can additionally or alternatively include Block S150, which includes functionality for, at an output device, manipulating an object in an environment of the user, based upon a set of instructions derived from the output and provided to the output device. Block S150 can transform outputs of the predictive model of Blocks S110-S140 into digitally implemented changes to operation states or outputs of one or more devices in the environment(s) of the user(s) associated with the method 100. Block S150 can be implemented through the online system 240 and associated network 220 in communication with one or more client devices 210 and/or other output devices 214 in user environments, as shown in FIGS. 2A and 2B. Block S150 can additionally or alternatively be implemented using any other suitable system components.

In one application of Block S150, object manipulation in association with a client device can include modulating rules of a recommendation unit 244 of the online system 240 described above in order to increase user interaction with the online system 240 based upon the outputs of the predictive model, such that the recommendation unit adjusts presentation of objects in digital content provided to the user (e.g., at a client device in the user’s environment). The recommendation unit can thus suggest one or more actions to a user (a “viewing user”) interacting with an application executing on an associated client device to increase the viewing user’s interaction with the online system 240. For example, the recommendation unit can provide a suggestion for the viewing user to view a product page of a third-party vendor as well as a link to the product page enabling the user to do so, based upon a sequence of behavior events of the user. In other examples, a recommendation unit can encourage the viewing user to create an event, to identify a user in a photo, to join a group, or to perform another suitable action with the online system 240. Additional aspects of embodiments, variations, and examples of a recommendation unit are further described in U.S. Pat. Application No. 13/549,080, filed on Jul. 13, 2012, which is hereby incorporated by reference in its entirety.

In another application of Block S150, a content selection unit associated with the content store 243 of the online system 240 can select one or more content items for communication to a client device 210 to be presented to a user, based upon outputs of Block S140 and in relation to manipulation of digital content in user environments. Content items eligible for presentation to the user can be retrieved from the content store 243 or from another source. A content item eligible for presentation to the user is a content item associated with at least a threshold number of targeting criteria satisfied by characteristics of the user or is a content item that is not associated with targeting criteria, wherein at least one targeting criterion can be based upon a threshold condition satisfied by probability outputs associated with future behavior events. For instance, a threshold condition of a probability value greater than a threshold value (e.g., from 0 to 1) can be used to determine if content items (e.g., such as content items described above) should be presented to a user. Content items eligible for presentation to the user can additionally or alternatively include content items associated with bid amounts, wherein outputs of Block S140 can be used to adjust or otherwise optimize expected value from interactions between users and presented content. In a related example, if a user has purchased or has a high likelihood of purchasing an object (e.g., a camera) in the future, alternative content (e.g., camera accessories) can be provided to the user in order to increase expected value from content provided from an external entity. Selecting content items associated with bid amounts and content items not associated with bid amounts is further described in U.S. Pat. Application No. 13/545,266, filed on Jul. 10, 2012, which is hereby incorporated by reference in its entirety.

In another application of Block S150, related to provision of content associated with external entities (e.g., third parties), generation of a new tracking object in digital space can be based upon a threshold condition satisfied by probability outputs associated with future behavior events. For instance, satisfaction of a threshold condition of a probability value greater than a threshold value (e.g., from 0 to 1) can be used to create and embed a new tracking pixel object within electronic content available to the user, wherein the new tracking pixel object can be used for monitoring occurrence of the proposed future behavior with the second tracking pixel object. In more detail, based upon high probability of a future behavior event associated with user purchase of an item, a new tracking pixel can be embedded in a product purchase checkout page of a vendor website to track performance of the predicted user behavior and/or deliver insights to the online system 240 and/or third party.

In another application of Block S150, the online system 240 and/or network 220 can facilitate delivery of control instructions to output devices in the environment of the user. As described above, the output devices displays can include one or more of: light emitting elements, audio output devices, haptic output devices, temperature modulating devices, olfactory stimulation devices, virtual reality devices, augmented reality devices, other stimulation devices, delivery vehicles (e.g., aerial delivery vehicles, terrestrial delivery vehicles, nautical delivery vehicles, etc.), printing devices, and/or any other suitable output devices. In some variations, such output devices 214 can be wirelessly coupled or otherwise coupled to the network 220, external system(s) 230, and/or input devices 212, in order to receive control instructions for entering or transitioning between operation states. In relation to object manipulation in Block S150, anticipated user behaviors, as determined from threshold conditions associated with probability outputs can be used to generate control instructions for modification of operation states of devices in user environments. Such operation states can be associated with device activation, device inactivation, device idling, stimulation output states (e.g., light output states, audio output states, temperature adjustment states, olfactory output states, etc.), delivery operation states of aerial or other delivery vehicles, printing states, states associated with electronic content provision to the user(s), and/or any other suitable output device states. In one specific application, in relation to a proposed future behavior event (e.g., a user having onset flu symptoms) having a probability above a threshold probability, Block S150 can include generating and providing instructions to a home control system that adjusts lighting, temperature, and audio stimuli in the user’s environment to increase comfort. In another specific application, in relation to a proposed future behavior event (e.g., a user purchasing a product) having a probability above a threshold probability, Block S150 can include generating and providing instructions to a delivery platform (e.g., a drone delivery platform) that prepares a shipment and/or performs pre-flight drone state operations to facilitate efficient delivery of the product to the user. In another specific application, in relation to a proposed future behavior event (e.g., a user desiring a makeover) having a probability above a threshold probability, Block S150 can include generating and providing instructions to a virtual reality or augmented reality system that for adjustment of features of the user’s avatar. Other specific applications of Block S150, in relation to output device control, can be implemented in any other suitable manner.

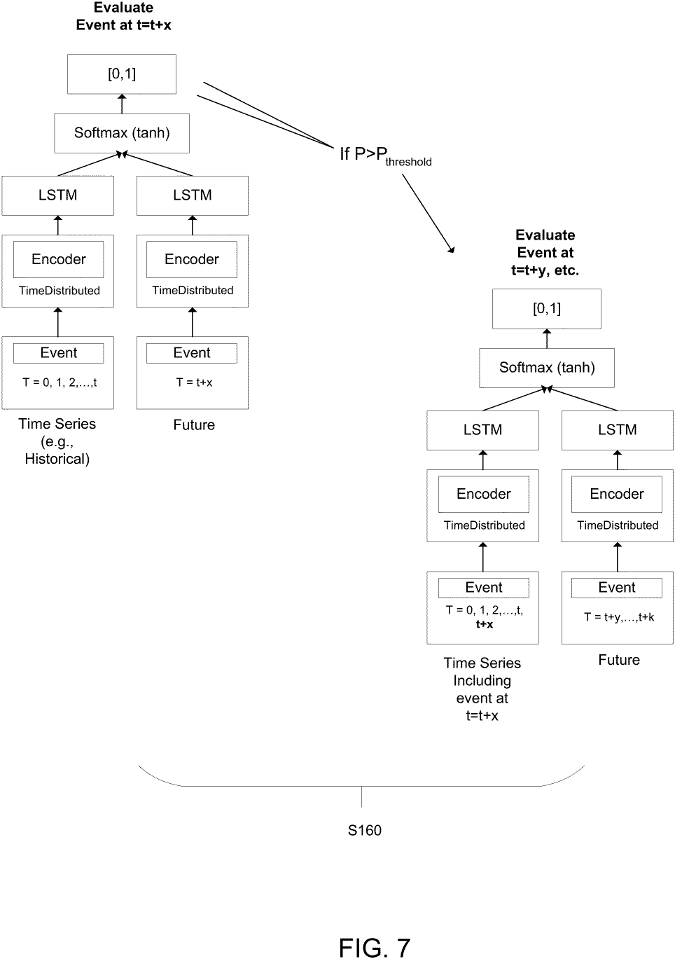

The method 100 can optionally include additional blocks associated with predictive model input layers, output layers, and/or other layers. For instance, as shown in FIG. 7, in relation to satisfaction of the threshold probability condition for a proposed future behavior event, the method 100 can further include processing a) the proposed future embedding (that satisfied the threshold condition) with the first series of time-distributed embeddings in a subsequent instance of the first flow and b) a different proposed future embedding of a second proposed future behavior of a user at a second future time point subsequent to the first set of time points in a subsequent instance of the second flow S160. The output of the subsequent run of the predictive model can then be used to indicate plausibility of occurrence of the second proposed future behavior. As such, future behaviors that have not occurred, but have a high likelihood of occurring, can be used to predict plausibility of other future behavior events for the user(s).

Then, in relation to Block S150, object manipulation through output devices can then be implemented in a way that incentivizes performance of the proposed future behavior that has a high likelihood of occurring, thereby potentially affecting likelihood of a second proposed future behavior (that may be of interest to owners of the online system or third party).

The method 100 can optionally include additional blocks associated with shared latent spaces for generated behavior event elements. For instance, the method 100 can include generating comparisons for different behavior event subcomponents or embeddings due to benefits of shared latent space (e.g., based upon positions and orientations of vector of embeddings). In one variation, the method 100 can include identifying a similarity parameter between a first embedding and a second embedding of the first series of time-distributed embedding, and generating an analysis of an association between a first behavior event corresponding to the first embedding and a second behavior event corresponding to the second behavior. In relation to selection of proposed future behavior events for input to the predictive model, similarity analyses can be used to generate the proposed future embedding from a candidate set of behaviors based upon the association between the first behavior event and the second behavior event. However, analyses of behavior event elements in shared latent space can be implemented in any other suitable manner.

### 4. Conclusion

The method 100 and system 200 can confer benefits and/or technological improvements, several of which are described herein. For example, the method 100 and system 200 can produce combined data structures that characterize aspects of an extremely large dataset, wherein the combined data structures reside in shared latent space. Such data structures and processing methods can be used to efficiently generate comparisons between an extremely large amount of data capturing a large number of events for a large number of users over a long duration of time. Even further, data structures occupying shared latent space can be used to follow, characterize, and generate predictions from erratic streams of consciousness for users in a manner not achievable before.

The method 100 and system 200 can additionally efficiently process such large amounts of data by use of embedding operations. Such operations can improve computational performance for data in a way that has not been previously achieved, and could never be performed efficiently by a human. Such operations can additionally improve function of an online system for delivering content to a user and/or handling user-generated content, wherein enhancements to performance of the online system provide improved functionality and application features to users of the online system. In anticipating behavior events, outputs of the method 100 and system 200 can eliminate user burden in relation to certain tasks, thereby improving functionality of the online system in adding value to and engaging users.

Related to this, the method 100 and system 200 can learn robust encoder operations that output embeddings in an optimized manner, by training using large datasets. The method 100 and system 200 can further employ non-typical use of sensors. For instance, the method 100 and system 200 can employ sensors typically used to characterize historical behaviors, to characterize behaviors that have not yet been performed. As such, the method 100 and system 200 can provide several technological improvements.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
generating a first series of behavior event elements describing a first set of behavior events across a first set of time points, wherein each of the first series of behavior event elements are generated from observed user interactions with an online system, each of the first series of behavior event elements comprising a set of components comprising a time component, an object component, and an action component associated with an interaction with the object component;
generating a first series of time-distributed embeddings of the behavior event elements by encoding the first series of behavior event elements with a set of operations applied to the set of components;
generating a proposed future embedding of a proposed future behavior event of a user at a future time point subsequent to the first set of time points, wherein the first series of time-distributed embeddings and the proposed future embedding are in the same latent space;
with a predictive model comprising a set of computer-implemented rules, transforming the first series of time-distributed embeddings and the proposed future embedding into an output comprising a plausibility metric describing plausibility of occurrence of the proposed future behavior event of a user; and
generating instructions for manipulating an object in an environment of the user, wherein the instructions are selected based on the output.

2. The method of claim 1, wherein transforming the first series of time-distributed embeddings and the proposed future embedding comprises:
generating and training a recursive neural network (RNN) with architecture having:
an input layer for the first series of behavior event elements and the proposed future behavior event element;
an encoder layer receiving outputs of the input layer and implementing the set of embedding operations, a set of machine learning operations mapped to embedding types of the first series of time-distributed embeddings and the proposed future embedding, and a concatenation operation;
a long short-term memory (LSTM) block that processes outputs of the encoder layer; and
an output layer that generates the output.

3. The method of claim 1, wherein the object component describes an object of a set of direct objects available for interaction with the user within the online system, and the action component comprises at least one of a searching action, a purchasing action, and a viewing action applied to the object by the user within the online system.

4. The method of claim 1, wherein the plausibility metric describes a probability of occurrence of the proposed future behavior within a sequence of events distributed about the future time point.

5. The method of claim 4, further comprising:
generating a comparison between the plausibility metric and a threshold probability condition.

6. The method of claim 5, further comprising:
generating a second series of time-distributed embeddings that represent the proposed future embedding and the first series of time-distributed embeddings; generating a second proposed future embedding of a second proposed future behavior of a user at a second future time point subsequent to the first set of time points in a subsequent instance of the second flow; and
generating a second output associated with plausibility of occurrence of the second proposed future behavior.

7. The method of claim 6, further comprising:
prompting the user, at an output device associated with the user, to perform the proposed future behavior.

8. The method of claim 7, wherein:
the output device comprises at least one of a display, an audio output device, and a light output device, and the method comprises generating and transmitting control instructions to adjust an operation state of the output device.

9. The method of claim 1, wherein the first series of behavior event elements is associated with a population of users sharing a set of demographic traits, wherein the user is a member of the population of users.

10. The method of claim 1, wherein each of the first series of behavior event elements further comprising a pixel identifier component that is associated with a tracking pixel object defined in source code of electronic content provided to the user through the online system.

11. The method of claim 10, further comprising:
embedding a second tracking pixel object within second electronic content available to the user, and monitoring occurrence of the proposed future behavior with the second tracking pixel object.

12. The method of claim 1, further comprising:
identifying a similarity parameter between a first embedding and a second embedding of the first series of time-distributed embeddings; and
generating an analysis of an association between a first behavior event corresponding to the first embedding and a second behavior event corresponding to the second behavior.

13. The method of claim 12, further comprising:
generating the proposed future embedding from a candidate set of behaviors based upon the association between the first behavior event and the second behavior event.

14-20. (canceled)

21. A computer program product comprising a non-transitory computer-readable storage medium containing computer program code for:
generating a first series of behavior event elements describing a first set of behavior events across a first set of time points, wherein each of the first series of behavior event elements are generated from observed user interactions with an online system, each of the first series of behavior event elements comprising a set of components comprising a time component, an object component, and an action component associated with an interaction with the object component;
generating a first series of time-distributed embeddings of the behavior event elements by encoding the first series of behavior event elements with a set of operations applied to the set of components;
generating a proposed future embedding of a proposed future behavior event of a user at a future time point subsequent to the first set of time points, wherein the first series of time-distributed embeddings and the proposed future embedding are in the same latent space;
with a predictive model comprising a set of computer-implemented rules, transforming the first series of time-distributed embeddings and the proposed future embedding into an output comprising a plausibility metric describing plausibility of occurrence of the proposed future behavior event of a user; and
generating instructions for manipulating an object in an environment of the user, wherein the instructions are selected based on the output.

22. The computer program product of claim 21, wherein transforming the first series of time-distributed embeddings and the proposed future embedding comprises:
generating and training a recursive neural network (RNN) with architecture having:
an input layer for the first series of behavior event elements and the proposed future behavior event element;
an encoder layer receiving outputs of the input layer and implementing the set of embedding operations, a set of machine learning operations mapped to embedding types of the first series of time-distributed embeddings and the proposed future embedding, and a concatenation operation;
a long short-term memory (LSTM) block that processes outputs of the encoder layer; and
an output layer that generates the output.

23. The computer program product of claim 21, wherein the object component describes an object of a set of direct objects available for interaction with the user within the online system, and the action component comprises at least one of a searching action, a purchasing action, and a viewing action applied to the object by the user within the online system.

24. The computer program product of claim 21, wherein the plausibility metric describes a probability of occurrence of the proposed future behavior within a sequence of events distributed about the future time point.

25. The computer program product of claim 24, the non-transitory computer-readable storage medium further containing computer program code for:
generating a comparison between the plausibility metric and a threshold probability condition.

26. The computer program product of claim 25, the non-transitory computer-readable storage medium further containing computer program code for:
generating a second series of time-distributed embeddings that represent the proposed future embedding and the first series of time-distributed embeddings;
generating a second proposed future embedding of a second proposed future behavior of a user at a second future time point subsequent to the first set of time points in a subsequent instance of the second flow; and
generating a second output associated with plausibility of occurrence of the second proposed future behavior.

27. The computer program product of claim 26, the non-transitory computer-readable storage medium further containing computer program code for:
prompting the user, at an output device associated with the user, to perform the proposed future behavior, thereby promoting occurrence of the second proposed behavior by the user.
